(19) United States
(12) Patent Application Publication
(10) Pub. No.: US 2017/0295174 A1
(43) Pub. Date: Oct. 12, 2017

(54) ELECTRONIC DEVICE, SERVER, AND METHOD FOR AUTHENTICATING BIOMETRIC INFORMATION

(71) Applicant: Samsung Electronics Co., Ltd., Suwon-si (KR)

(72) Inventors: Kyung Dong KIM, Suwon-si (KR); Boo Hyun CHO, Yongin-si (KR)

(21) Appl. No.: 15/481,922

(22) Filed: Apr. 7, 2017

(30) Foreign Application Priority Data
Apr. 7, 2016 (KR) 10-2016-0042563

(51) Int. Cl. H04L 29/06; G06F 21/46

(52) U.S. Cl. CPC H04L 63/0861; H04L 63/0838; G06F 21/46

(57) ABSTRACT

An electronic device is provided. The electronic device includes a communication circuit configured to communicate with a user terminal and an authentication server, a memory configured to store a plurality of one time password (OTP) generation modules and a plurality of module identification information respectively corresponding to the plurality of OTP generation modules, and a processor electrically connected with the communication circuit and the memory. The processor is configured to transmit, to the authentication server, module identification information, which is associated with account information of the user terminal, from among the plurality of module identification information, in response to a registration request for biometric information received from the user terminal, and transmit, to the user terminal, the module identification information and an OTP generation module corresponding to the module identification information, when the authentication server verifies the biometric information using the user terminal.

### CROSS-REFERENCE TO RELATED APPLICATION(S)

This application claims the benefit under 35 U.S.C. §119(a) of a Korean patent application filed on Apr. 7, 2016 in the Korean Intellectual Property Office and assigned Serial number 10-2016-0042563, the entire disclosure of which is hereby incorporated by reference.

### TECHNICAL FIELD

The present disclosure relates to a technology for biometric information-based authentication.

### BACKGROUND

With the development of electronic technologies, various types of electronic products are being developed and distributed. In particular, an electronic device, which has a variety of functions, such as a smartphone, a tablet personal computer (PC), or the like is being widely supplied nowadays.

The electronic device may sense biometric information (e.g., a fingerprint, an iris, or the like) of a user and may provide a service (e.g., a financial transaction, a card payment, or the like), which needs to be authenticated by the user, by using the sensed biometric information.

An authentication method using biometric information may authenticate the user by using a user terminal (e.g., a smartphone, a tablet PC, or the like) and an authentication server for authentication of the biometric information according to the related art. In this case, a service provider providing a financial service, a payment service, or the like that needs to be authenticated by the user did not verify the authentication. In particular, if a security issue occurs in the user terminal or the authentication server, the service provider may be damaged due to the security issue in a defenseless state.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device, a server, and a method capable of performing biometric authentication together with a service provider.

In accordance with an aspect of the present disclosure, an electronic device is provided. The electronic device includes a memory configured to store pieces of identification information, and a processor. The processor is configured to receive a registration request for biometric information associated with a user from a first external electronic device, transmit, to a second external electronic device, identification information, which corresponds to account information of the first external electronic device, from among the pieces of identification information, based at least on the reception such that the second external electronic device authenticates the biometric information about the first external electronic device, and transmit, to the first external electronic device, identification information and encryption information corresponding to the identification information, based at least on authentication of the biometric information.

In accordance with another aspect of the present disclosure, a server is provided. The server includes a communication circuit configured to communicate with a user terminal and an authentication server, a memory configured to store a plurality of one time password (OTP) generation modules and a plurality of module identification information respectively corresponding to the plurality of OTP generation modules, and a processor electrically connected with the communication circuit and the memory. The processor is configured to transmit, to the authentication server, module identification information, which is associated with account information of the user terminal, from among the pieces of module identification information, in response to a registration request for biometric information received from the user terminal, and transmit, to the user terminal, the module identification information and an OTP generation module corresponding to the module identification information, when the authentication server verifies the biometric information by using the user terminal.

In accordance with another aspect of the present disclosure, an electronic device is provided. The electronic device includes a communication circuit configured to communicate with a service providing server and an authentication server, a biometric sensor configured to perform biometric recognition, a memory configured to store a plurality of biometric information and a plurality of identification information respectively corresponding to the plurality of biometric information, and a processor electrically connected with the communication circuit, the biometric sensor, and the memory. The processor may be configured to transmit a registration request for one biometric information of the plurality of biometric information to the service providing server, receive a verification request of the one biometric information from the authentication server, when the authentication server receives module identification information corresponding to a one time password (OTP) generation module from the service providing server in response to the registration request, and receive the module identification information and the OTP generation module from the service providing server, when information that is the same as the one biometric information is obtained through the biometric sensor.

In accordance with another aspect of the present disclosure, a method is provided. The method includes transmitting, to an authenticating server, module identification information, which is associated with account information of a user terminal, from among a plurality of module identification information, in response to a registration request of biometric information received from the user terminal, and transmitting, to the user terminal, the module identification information and a one time password (OTP) generation module corresponding to the module identification information, when the authentication server verifies the biometric information by using the user terminal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an operating environment of an electronic device and a server according to an embodiment of the present disclosure;

FIG. 2 schematically illustrates pieces of information stored in an electronic device and a server according to an embodiment of the present disclosure;

FIG. 3 is a block diagram illustrating a configuration of a server according to an embodiment of the present disclosure;

FIG. 4 is a block diagram illustrating a configuration of an electronic device according to an embodiment of the present disclosure;

FIG. 5 is a flowchart for describing a biometric information authentication method according to an embodiment of the present disclosure;

FIG. 6 is a flowchart for describing a biometric information authentication method according to an embodiment of the present disclosure;

FIG. 7 is a flowchart for describing a biometric information authentication method according to an embodiment of the present disclosure;

FIG. 8 illustrates an electronic device in a network environment according to various embodiments of the present disclosure;

FIG. 9 illustrates a block diagram of an electronic device according to various embodiments of the present disclosure; and

FIG. 10 illustrates a block diagram of a program module according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions ‘have’, ‘may have’, ‘include’ and ‘comprise’, or ‘may include’ and ‘may comprise’ used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, a first user device and a second user device indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. central processing unit (CPU), for example, a “processor configured to perform A, B, and C” may mean a dedicated processor (e.g., an embedded processor) for performing a corresponding operation or a generic-purpose processor (e.g., a CPU) or an application processor (AP)) which may perform corresponding operations by executing one or more software programs which are stored in a memory device.

All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

According to various embodiments of the present disclosure, an electronic device may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Moving Picture Experts Group (MPEG-1 or MPEG-2) audio layer 3 (MP3) players, mobile medical devices, cameras, or wearable devices. According to various embodiments of the present disclosure, a wearable device may include at least one of an accessory type of a device (e.g., a timepiece, a ring, a bracelet, an anklet, a necklace, glasses, a contact lens, or a head-mounted-device (HMD)), one-piece fabric or clothes type of a device (e.g., electronic clothes), a body-attached type of a device (e.g., a skin pad or a tattoo), or a bio-implantable type of a device (e.g., implantable circuit).

According to another embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or Play Station™), electronic dictionaries, electronic keys, camcorders, electronic picture frames, or the like.

According to another embodiment, the electronic device may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global navigation satellite system (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), point of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). According to various embodiments of the present disclosure, the electronic device may be one of the above-described devices or a combination thereof. According to an embodiment of the present disclosure, an electronic device may be a flexible electronic device. Furthermore, according to an embodiment of the present disclosure, an electronic device may not be limited to the above-described electronic devices and may include other electronic devices and new electronic devices according to the development of technologies.

Hereinafter, according to various embodiments of the present disclosure, electronic devices will be described with reference to the accompanying drawings. The term “user” used herein may refer to a person who uses an electronic device or may refer to a device (e.g., an artificial intelligence electronic device) that uses an electronic device.

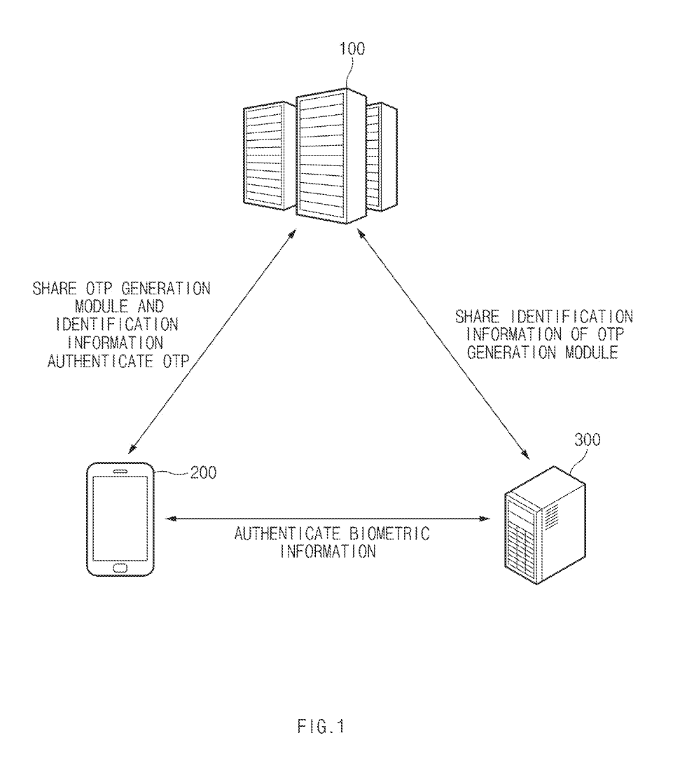

FIG. 1 illustrates an operating environment of an electronic device and a server according to an embodiment of the present disclosure.

Referring to FIG. 1, a service providing server 100, a user terminal 200, and an authentication server 300 may communicate with each other.

According to an embodiment of the present disclosure, the service providing server 100 may be a server that provides a user with a service that needs biometric authentication. The service providing server 100 may provide a service, for example, a financial service, a credit payment service, or the like.

According to an embodiment of the present disclosure, the user terminal 200 may use a service provided by the service providing server 100 and may be a terminal that is capable of performing authentication by using the authentication server 300. The user terminal 200 may be a portable electronic device, for example, a smartphone, a tablet PC, or the like. The user terminal 200 may include a biometric sensor that is capable of obtaining biometric information, such as a fingerprint, an iris, or the like, from the user. As another example, the user terminal 200 may be an electronic device such as a desktop PC, a notebook computer, or the like. The user terminal 200 may be connected with an external biometric information sensing module and may obtain biometric information of the user by using the external biometric information sensing module.

According to various embodiments of the present disclosure, the authentication server 300 may be a server that is capable of providing biometric authentication using the user terminal 200. The authentication server 300 may be, for example, a fast identity online (FIDO) server.

The service providing server 100 and the authentication server 300 may share identification information of a one time password (OTP) generation module. For example, the identification information of the OTP generation module may be shared in the case where the registration of the biometric information is requested from the user terminal 200. The service providing server 100 and the authentication server 300 may not share the OTP generation module.

The user terminal 200 and the authentication server 300 may authenticate the biometric information. For example, if the authentication of the biometric information is requested, the authentication server 300 may request the user terminal 200 to authenticate the biometric information. After verifying the biometric information, the user terminal 200 may transmit a key value associated with the biometric information to the authentication server 300, and the authentication server 300 may verify the key value to complete the authentication. The biometric information may be stored in, for example, the user terminal 200.

The service providing server 100 and the user terminal 200 may share the OTP generation module and the identification information of the OTP generation module. For example, if the biometric information is normally registered, the service providing server 100 may transmit the identification information of the OTP generation module, which is shared with the authentication server 300, and the OTP generation module corresponding to the identification information to the user terminal 200, and the user terminal 200 may store the OTP generation module and the identification information. The service providing server 100 and the user terminal 200 may perform OTP authentication. For example, if the biometric information is authenticated between the user terminal 200 and the authentication server 300, the service providing server 100 may perform the OTP authentication by comparing an OTP generated by the user terminal 200 with an OTP generated by the service providing server 100.

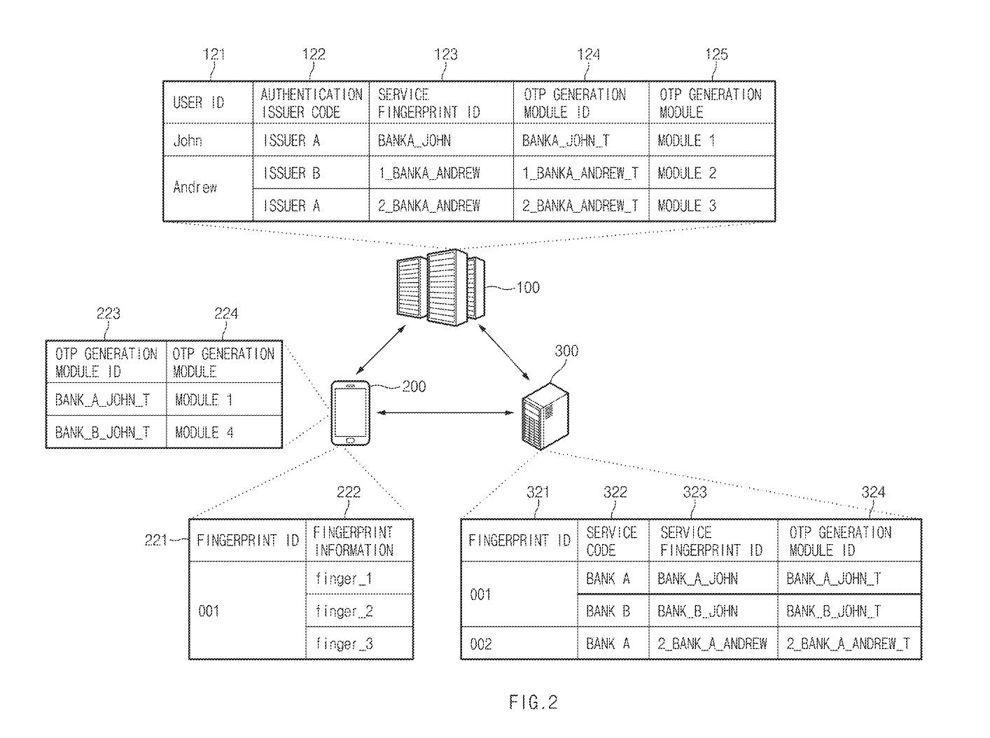

FIG. 2 schematically illustrates pieces of information stored in an electronic device and a server according to an embodiment of the present disclosure.

Referring to FIG. 2, the service providing server 100, the user terminal 200, and the authentication server 300 may store various pieces of information and may share the stored information with each other.

According to various embodiments of the present disclosure, the service providing server 100 may store, for example, a user identifier (ID) 121, an authentication issuer code 122, a service fingerprint ID 123, an OTP generation module ID 124, and an OTP generation module 125.

The user ID 121 (or account information of a user) may include, for example, account information (e.g., John) of the user of the user terminal 200. The user ID 121 may also include account information (e.g., Andrew) of another user terminal.

The authentication issuer code 122 (or an authentication issuer identification code) may be, for example, a code for identifying an authentication issuer operating the authentication server 300. The authentication issuer code 122 may include a code (e.g., Issuer A) received from the authentication server 300 and may include a code (e.g., Issuer B) received from another authentication server.

The service fingerprint ID 123 (or identification information of biometric information for each service) may be, for example, identification information that is assigned to fingerprint information (or biometric information) used for each service.

The OTP generation module ID 124 (or module identification information) may be, for example, identification information for identifying the OTP generation module 125.

The OTP generation module 125 may be, for example, a program module that is capable of generating an OTP.

The user terminal 200 may store, for example, a fingerprint ID 221, fingerprint information 222, an OTP generation module ID 223, and an OTP generation module 224 for each generation module ID.

The fingerprint ID 221 (or the identification information of the biometric information) may be, for example, identification information for identifying fingerprint information (or biometric information). One fingerprint ID (e.g., 001) may be assigned to pieces of fingerprint information (e.g., finger_1, finger_2, and finger_3).

The fingerprint information 222 (or biometric information) may be information, for example, an image or the like obtained by scanning a fingerprint (or a body) of the user. The fingerprint information 222 may include information about a point of a part of the fingerprint of the user.

The OTP generation module ID 223 and OTP generation module 224 may include, for example, the OTP generation module ID 124 and the OTP generation module 125 (e.g., bank_A_John_T and module 1) received from the service providing server 100. The OTP generation module ID 223 and OTP generation module 224 may include the OTP generation module ID and the OTP generation module (e.g., bank_B_John_T and module 4) received from another service providing server.

The authentication server 300 may store, for example, a fingerprint ID 321, a service code 322, a service fingerprint ID 323, and an OTP generation module ID 324.

The fingerprint ID 321 may include, for example, a fingerprint ID (e.g., 001) received from the user terminal 200. The fingerprint ID 321 may include a fingerprint ID (e.g., 002) received from another user terminal.

The service code 322 (or a service identification code) may be, for example, a code for identifying a service provider operating the service providing server 100. The service code 322 may include a code (e.g., Bank A) received from the service providing server 100 and may include a code (e.g., Bank B) received from another service providing server.

The service fingerprint ID 323 may include ID (e.g., 1_bank_A_John and 2_bank_A_Andrew) received from the service providing server 100 and may include ID (e.g., 1_bank_B John) received from another service providing server.

The OTP generation module ID 324 may include ID (e.g., 1_bank_A_John_T and 2_bank_A_Andrew_T) received from the service providing server 100 and may include ID (e.g., 1_bank_B_John_T) received from another service providing server.

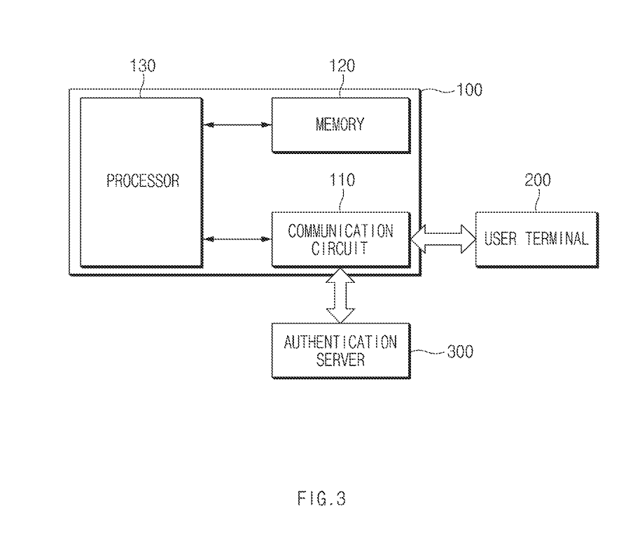

FIG. 3 is a block diagram illustrating a configuration of a server according to an embodiment of the present disclosure.

Referring to FIG. 3, the service providing server 100 may include a communication circuit 110, a memory 120, and a processor 130.

According to various embodiments of the present disclosure, the service providing server 100 may be a server that provides a service that needs security. For example, the service providing server 100 may provide various services such as a financial service, a payment service, and the like that are capable of providing the service after performing authentication by using biometric information.

According to various embodiments of the present disclosure, the communication circuit 110 may communicate with the user terminal 200 and the authentication server 300. The communication circuit 110 may communicate with the user terminal 200 and the authentication server 300 over a wired or wireless network. For example, the communication circuit 110 may transmit or receive various pieces of information illustrated in FIG. 2 to or from the user terminal 200 and the authentication server 300.

According to various embodiments of the present disclosure, the memory 120 may store a plurality of OTP generation modules and pieces of module identification information that are respectively correspond to the plurality of OTP generation modules. The memory 120 may be a nonvolatile memory and may be a secure memory of which the security is strengthened.

According to various embodiments of the present disclosure, the processor 130 may be electrically connected with the communication circuit 110 and the memory 120. The processor 130 may control the communication circuit 110 and the memory 120.

According to various embodiments of the present disclosure, for authentication needed when the service is provided, the processor 130 may register the biometric information stored in the user terminal 200.

According to an embodiment of the present disclosure, the processor 130 may receive a registration request for the biometric information from the user terminal 200. To perform the authentication by using the biometric information stored in the user terminal 200, the processor 130 may receive the registration request for the corresponding biometric information from the user terminal 200.

According to an embodiment of the present disclosure, the processor 130 may transmit identification information of an OTP generation module (hereinafter referred to as “module identification information”), which is associated with account information of the user terminal 200, from among pieces of module identification information to the authentication server 300 in response to the registration request.

For example, the processor 130 may correlate module identification information with the account information. The processor 130 may correlate the account information, which is received from the user terminal 200, with one of pieces of module identification information stored in the memory 120. The processor 130 may correlate account information, module identification information, and a service identification code associated with the service with each other. The service identification code may be a code for identifying a service provider that provides the service by using the service providing server 100 and may be information stored in the service providing server 100 in advance. The processor 130 may store the account information, the module identification information, and the service identification code, which are correlated with each other, in the memory 120.

The processor 130 may generate the account information, the module identification information, and identification information of biometric information for each service corresponding to the service identification code. The processor 130 may generate identification information about the registration-requested biometric information to identify the registration-requested biometric information. The processor 130 may correlate the account information, the module identification information, the service identification code, and the identification information of the biometric information for each service with each other.

The processor 130 may transmit the module identification information associated with the account information of the user terminal 200 to the authentication server 300. The processor 130 may transmit the service identification code or the identification information of the biometric information for each service to the authentication server 300 together with the module identification information. According to various embodiments of the present disclosure, the OTP generation module corresponding to the module identification information may not be transmitted to the authentication server 300.

According to an embodiment of the present disclosure, if the authentication server 300 verifies the biometric information by using the user terminal 200, the processor 130 may transmit the module identification information and the OTP generation module corresponding to the module identification information to the user terminal 200.

For example, if the authentication server 300 verifies the biometric information by using the user terminal 200, the processor 130 may receive, from the authentication server 300, the identification information of the biometric information for each service associated with the module identification information and an authentication issuer identification code associated with the authentication server 300. After correlating the authentication issuer identification code of the biometric information with the identification information of the biometric information for each service, the processor 130 may store the authentication issuer identification code of the biometric information in the memory 120.

The processor 130 may transmit the module identification information associated with the biometric information verified by the authentication server 300 to the user terminal 200. In addition, the processor 130 may transmit the OTP generation module corresponding to the module identification information to the user terminal 200. In a process of registering the biometric information, the service providing server 100 and the authentication server 300 may store the same module identification information associated with the registered biometric information. The service providing server 100 and the user terminal 200 may store the same module identification information and the same OTP generation module associated with the registered biometric information.

According to various embodiments of the present disclosure, the processor 130 may perform authentication by using the biometric information registered in the authentication server 300 in response to a request of the user terminal 200.

According to an embodiment of the present disclosure, if the user terminal 200 authenticates the biometric information by using the authentication server 300, the processor 130 may receive an OTP of the user terminal 200, which is generated by OTP generation module stored in the user terminal 200, from the user terminal 200.

For example, if an authentication request of the biometric information is received from the user terminal 200, the processor 130 may request authentication from the authentication server 300. For example, the processor 130 may transmit the identification information of the biometric information for each service or the module identification information to the authentication server 300 together with the request.

If the authentication server 300 authenticates the received identification information of the biometric information for each service or the received biometric information corresponding to the module identification information, the processor 130 may receive an OTP generated by the OTP generation module corresponding to the module identification information from the user terminal 200. The processor 130 may receive the module identification information stored in the user terminal 200 from the user terminal 200 together with the OTP of the user terminal 200.

According to an embodiment of the present disclosure, if the OTP of the user terminal 200 is the same as the OTP of the service providing server 100 generated by an OTP generation module stored in a server, the processor 130 may transmit the authenticated result to the user terminal 200.

For example, the processor 130 may compare the OTP of the user terminal 200 with the OTP of the service providing server 100 generated by the OTP generation module corresponding to the module identification information. The processor 130 may generate an OTP, which is changed according to time, by using the OTP generation module. For example, the OTP generation module may periodically generate the OTP by using time (seed), a unique number (a secret key), a 128 bit encryption algorithm, and a combination of OTP generation algorithms. OTPs generated by the same OTP generation module at the same time may be the same as each other.

If the OTP of the user terminal 200 is the same as the OTP of the service providing server 100, the processor 130 may complete authentication and may provide the user terminal 200 with a service.

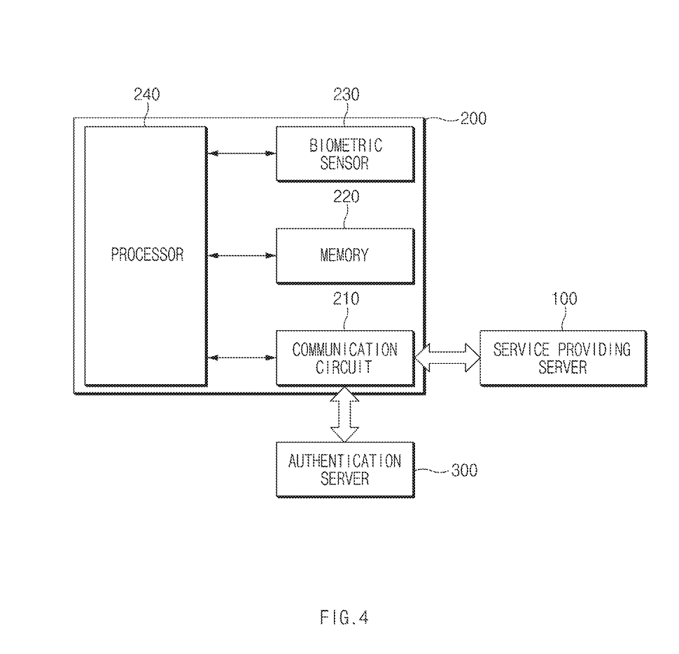

FIG. 4 is a block diagram illustrating a configuration of an electronic device according to an embodiment of the present disclosure.

Referring to FIG. 4, the user terminal 200 (i.e., an “electronic device”) may include a communication circuit 210, a memory 220, a biometric sensor 230, and a processor 240.

According to various embodiments of the present disclosure, the user terminal 200 may use a service provided by the service providing server 100. To use the service, the user terminal 200 may register biometric information and may perform authentication by using the registered biometric information.

According to various embodiments of the present disclosure, the communication circuit 210 may communicate with the service providing server 100 and the authentication server 300. The communication circuit 210 may communicate with the service providing server 100 and the authentication server 300 over a wired or wireless network. The communication circuit 210 may include, for example, a cellular module, a Wi-Fi module, or the like. For example, the communication circuit 210 may transmit or receive various pieces of information illustrated in FIG. 2 to or from the service providing server 100 and the authentication server 300.

According to various embodiments of the present disclosure, the memory 220 may store pieces of biometric information and pieces of identification information that respectively correspond to pieces of biometric information. The memory 220 may be the nonvolatile memory and may be the secure memory of which the security is strengthened. The memory 220 may store an authentication application, which performs authentication provided by the authentication server 300, and a service application that uses the service provided by the service providing server 100.

According to various embodiments of the present disclosure, the biometric sensor 230 may perform biometric recognition. The biometric sensor 230 may scan, for example, the body part of a user (e.g., a fingerprint, an iris, or the like) including a unique pattern for identifying the user. The biometric sensor 230 may obtain biometric information by scanning the body of the user.

According to various embodiments of the present disclosure, the processor 240 may be electrically connected with the communication circuit 210, the biometric sensor 230, and the memory 220. The processor 240 may control the communication circuit 210, the biometric sensor 230, and the memory 220. The processor 240 may execute the authentication application and the service application stored in the memory 220.

According to various embodiments of the present disclosure, for authentication needed when the service is used, the processor 240 may register the biometric information stored in the user terminal 200 in a server.

According to an embodiment of the present disclosure, the processor 240 may transmit a registration request for one among pieces of biometric information to the service providing server 100. For example, after executing the service application, the processor 240 may transmit, to the service providing server 100, the registration request for the biometric information needed to use the service. The processor 240 may transmit the identification information of the biometric information to the service providing server 100 or the authentication server 300.

According to an embodiment of the present disclosure, if the authentication server 300 receives module identification information from the service providing server 100 in response to the registration request, the processor 240 may receive a verification request of the biometric information from the authentication server 300. The processor 240 may scan the body part of the user by using the biometric sensor 230 in response to the verification request.

According to an embodiment of the present disclosure, if information that is the same as biometric information is obtained through the biometric sensor 230, the processor 240 may receive the module identification information and the OTP generation module from the service providing server 100. For example, if information that is the same as one of pieces of biometric information stored in the memory 220 is obtained through the biometric sensor 230, the processor 240 may transmit the result of the verification request to the authentication server 300. If the result is transmitted, the authentication server 300 may notify the service providing server 100 of the result, and the service providing server 100 may transmit the module identification information and the OTP generation module corresponding to the module identification information to the user terminal 200.

According to an embodiment of the present disclosure, the processor 240 may store the received module identification information and the received OTP generation module in the memory 220.

According to an embodiment of the present disclosure, the processor 240 may request authentication from the service providing server 100 by using the registered biometric information.

According to an embodiment of the present disclosure, the processor 240 may receive the authentication request for the biometric information from the user. For example, after executing the service application, the processor 240 may receive the authentication request for the biometric information needed to use the service from the user.

According to an embodiment of the present disclosure, if the authentication request for the biometric information is received from the user, the processor 240 may receive the identification information of the biometric information and the module identification information from the authentication server 300.

For example, if the authentication request for the biometric information is received, the processor 240 may determine whether the biometric information is registered. For example, the processor 240 may determine whether the biometric information is registered, by verifying the module identification information and the OTP generation module that are stored in the memory 220. If the registration of the biometric information is verified, the processor 240 may transmit the authentication request for the biometric information to the authentication server 300. The processor 240 may transmit the authentication request through the service providing server 100. The processor 240 may receive the identification information of the biometric information and the module identification information, which correspond to the authentication-requested biometric information, from the authentication server 300.

According to an embodiment of the present disclosure, if the biometric information corresponding to the identification information of the biometric information is detected through the biometric sensor 230, the processor 240 may generate an OTP by using the OTP generation module corresponding to the module identification information received from the authentication server 300 and may transmit the OTP to the service providing server 100. For example, if biometric information that is the same as the authentication-requested biometric information is obtained from the biometric sensor 230, the processor 240 may generate an OTP by using the OTP generation module corresponding to the module identification information received from the authentication server 300. The processor 240 may transmit the generated OTP to the service providing server 100. The processor 240 may transmit the module identification information to the service providing server 100 together with the OTP.

According to an embodiment of the present disclosure, if the OTP of the user terminal 200 is the same as the OTP generated by the service providing server 100, the processor 240 may receive the result of the authentication request from the service providing server 100. For example, the service providing server 100 may compare the OTP of the user terminal 200 with the OTP, which is generated by the OTP generation module in the service providing server 100, corresponding to the module identification information. If the OTP of the user terminal 200 is the same as the OTP of the service providing server 100, the processor 240 may receive the result of the authentication request from the service providing server 100.

If the authentication is completed, the user terminal 200 may use the service through the service providing server 100.

According to an embodiment of the present disclosure, an electronic device may include a memory that stores pieces of identification information, and a processor. The processor may be configured to receive a registration request for biometric information associated with a user from a first external electronic device, to transmit identification information, which corresponds to account information of the first external electronic device, from among the pieces of identification information to a second external electronic device based at least on the reception such that the second external electronic device authenticates the biometric information about the first external electronic device, and to transmit identification information and encryption information corresponding to the identification information to the first external electronic device based at least on authentication of the biometric information.

According to an embodiment of the present disclosure, a server may include a communication circuit configured to communicate with a user terminal and an authentication server, a memory in which a plurality of OTP generation modules and pieces of module identification information respectively corresponding to the plurality of OTP generation modules are stored, and a processor electrically connected with the communication circuit and the memory. The processor is configured to transmit module identification information, which is associated with account information of the user terminal, from among the pieces of module identification information to the authentication server in response to a registration request for biometric information received from the user terminal and to transmit the module identification information and an OTP generation module corresponding to the module identification information to the user terminal, if the authentication server verifies the biometric information by using the user terminal.

According to another embodiment, the processor may be configured to correlate the account information, the module identification information, and a service identification code, which is associated with a service, with each other and to store the account information, the module identification information, and the service identification code, which are correlated with each other, in the memory.

According to another embodiment, the processor may be configured to generate identification information of biometric information for each service that corresponds to the account information, the module identification information, and the service identification code and to transmit the account information, the module identification information, the service identification code, and the identification information of the biometric information for each service to the authentication server.

According to another embodiment, the processor may be configured to receive, from the authentication server, identification information of the biometric information associated with the module identification information and an authentication issuer identification code associated with the authentication server, if the authentication server verifies the biometric information by using the user terminal and to store the identification information of the biometric information and the authentication issuer identification code in the memory.

According to another embodiment, the processor may be configured to generate an OTP based on a current time, by using the OTP generation module.

According to another embodiment, the processor may be configured to receive an OTP of the user terminal, which is generated by the OTP generation module stored in the user terminal, from the user terminal if the user terminal authenticates the biometric information by using the authentication server and to transmit the authentication result to the user terminal if the OTP of the user terminal is the same as an OTP of the server generated by the OTP generation module stored in the server.

According to another embodiment, the processor may be configured to receive the module identification information stored in the user terminal from the user terminal together with the OTP of the user terminal and to compare the OTP of the user terminal with the OTP of the server generated by the OTP generation module corresponding to the module identification information.

According to an embodiment of the present disclosure, an electronic device may include a communication circuit configured to communicate with a service providing server and an authentication server, a biometric sensor configured to perform biometric recognition, a memory in which pieces of biometric information and pieces of identification information respectively corresponding to the pieces of biometric information are stored, and a processor electrically connected with the communication circuit, the biometric sensor, and the memory. The processor may be configured to transmit a registration request for one biometric information of the pieces of biometric information to the service providing server, to receive a verification request of the one biometric information from the authentication server if the authentication server receives module identification information corresponding to an OTP generation module stored in the service providing server from the service providing server in response to the registration request and to receive the module identification information and the OTP generation module from the service providing server if information that is the same as the one biometric information is obtained through the biometric sensor.

According to another embodiment, the processor may be configured to store the module identification information and the OTP generation module in the memory.

According to another embodiment, the processor may be configured to transmit identification information of the one biometric information corresponding to the one biometric information to the service providing server or the authentication server and to transmit the result of the verification request to the authentication server if the one biometric information corresponding to the identification information of the one biometric information is obtained through the biometric sensor.

According to another embodiment, the processor may be configured to receive the identification information of the one biometric information and the module identification information from the authentication server if an authentication request for the one biometric information is received from a user of the electronic device, to generate an OTP by using the OTP generation module corresponding to the module identification information received from the authentication server if the one biometric information corresponding to the identification information of the one biometric information is detected through the biometric sensor and to transmit the OTP to the service providing server.

According to another embodiment, the processor may be configured to determine whether the one biometric information is registered, if the authentication request for the one biometric information is received, to transmit the authentication request for the one biometric information to the authentication server if the registration of the one biometric information is verified and to receive the identification information of the one biometric information and the module identification information from the authentication server.

According to another embodiment, the processor may be configured to receive the result of the authentication request from the service providing server if the OTP is the same as an OTP generated by the service providing server.

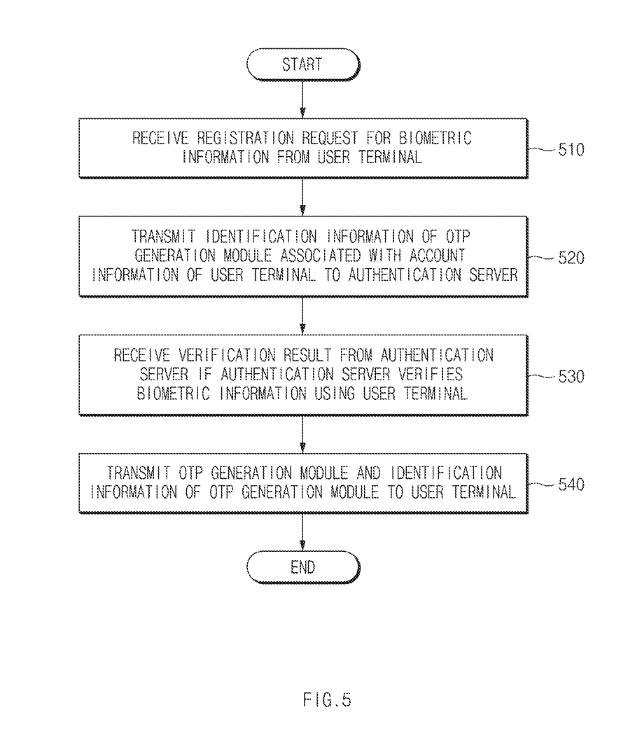

FIG. 5 is a flowchart for describing a biometric information authentication method according to an embodiment of the present disclosure.

The flowchart illustrated in FIG. 5 may include operations that the service providing server 100 illustrated in FIGS. 1 to 4 processes. Accordingly, although omitted below, details about the service providing server 100 described with reference to FIGS. 1 to 4 may be applied to the flowchart illustrated in FIG. 5.

Referring to FIG. 5, in operation 510, the service providing server 100 may receive a registration request for biometric information from the user terminal 200. For example, in the case where the service providing server 100 is a server of a card issuer that uses a fingerprint authentication scheme, the service providing server 100 may receive a registration request of fingerprint information, which is used for a payment, from the user terminal 200. The service providing server 100 may receive account information of the user terminal 200 together with the registration request.

In operation 520, the service providing server 100 may transmit identification information of an OTP generation module, which is associated with the account information of the user terminal 200, to the authentication server 300 in response to the registration request. For example, the service providing server 100 may correlate one of pieces of module identification information with the account information. The service providing server 100 may transmit the module identification information associated with the account information to the authentication server 300.

In operation 530, if the authentication server 300 verifies the biometric information by using the user terminal 200, the service providing server 100 may receive the verification result from the authentication server 300. For example, if the authentication server 300 verifies the registration-requested fingerprint information, through the user terminal 200, the service providing server 100 may receive the verification result from the authentication server 300 together with information for identifying the registration-requested fingerprint information.

In operation 540, the service providing server 100 may transmit the OTP generation module and identification information of the OTP generation module to the user terminal 200. For example, the service providing server 100 may transmit the module identification information associated with the account information of the user terminal 200 and the OTP generation module corresponding to the module identification information to the user terminal 200 in response to the reception of the verification result.

Through operations 510, 520, 530, and 540, the identification information about the biometric information stored in the user terminal 200 may be stored in the service providing server 100, and the OTP generation module corresponding to the user terminal 200 may be transmitted to the user terminal 200. Accordingly, the biometric information may be registered in the service providing server 100. In operations 510, 520, 530, and 540, the biometric information stored in the user terminal 200 may not be transmitted to the service providing server 100 or the authentication server 300.

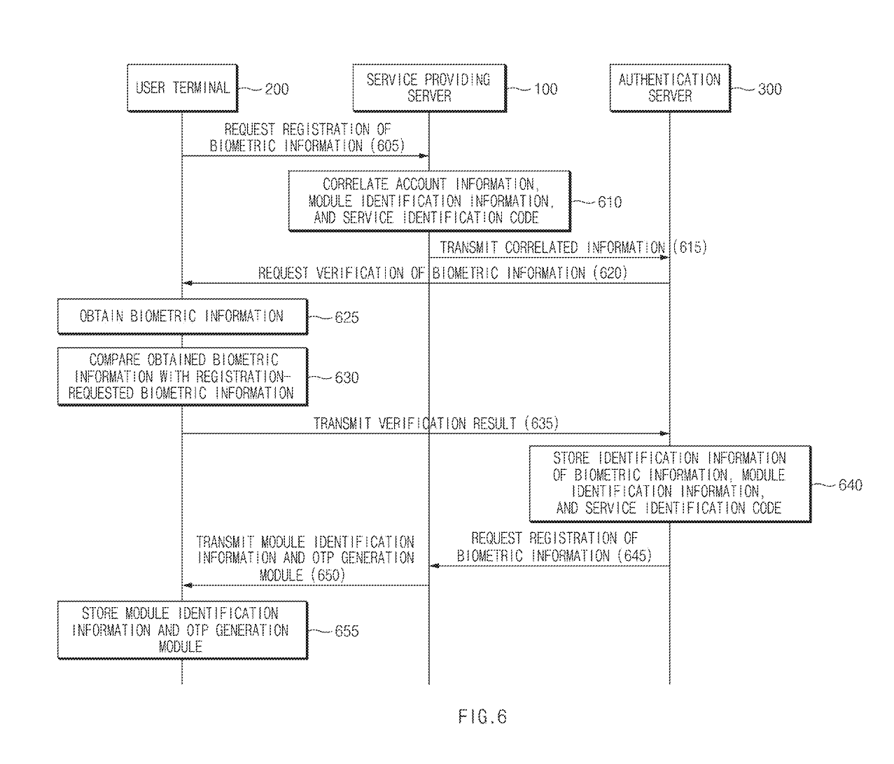

FIG. 6 is a flowchart for describing a biometric information authentication method according to an embodiment of the present disclosure.

The flowchart illustrated in FIG. 6 may include operations that the service providing server 100, the user terminal 200, and the authentication server 300 illustrated in FIGS. 1 to 4 process. Accordingly, although omitted below, details about the service providing server 100, the user terminal 200, and the authentication server 300 described with reference to FIGS. 1 to 4 may be applied to the flowchart illustrated in FIG. 6.

According to an embodiment of the present disclosure, the service providing server 100 may register biometric information in response to a request of the user terminal 200. An operation of registering the biometric information will be described below.

Referring to FIG. 6, in operation 605, the user terminal 200 may request the service providing server 100 to register the biometric information. For example, after a service application is executed, the user terminal 200 may receive the registration request of the biometric information needed to use a service from a user. The user terminal 200 may request the service providing server 100 to register the biometric information in response to a request of the user.

In operation 610, the service providing server 100 may correlate account information of the user terminal 200, identification information of an OTP generation module, and a service identification code with each other in response to the request. For example, the service providing server 100 may receive the account information from the user terminal 200 together with the request. The service providing server 100 may correlate the received account information with one of pieces of module identification information and the service identification code stored in the service providing server 100.

In operation 615, the service providing server 100 may transmit pieces of information that are correlated with each other, for example, at least a portion of the account information, the identification information of the OTP generation module, and the service identification code, to the authentication server 300. For example, the service providing server 100 may transmit the module identification information and the service identification code to the authentication server 300. The service providing server 100 may request the authentication server 300 to verify the biometric information. In this case, the service providing server 100 may not transmit the OTP generation module corresponding to the module identification information to the authentication server 300. Since the authentication server 300 stores only the module identification information without the OTP generation module, the security of an OTP may be maintained even though a security issue of the authentication server 300 occurs.

In operation 620, the authentication server 300 may request the user terminal 200 to verify the biometric information. For example, if the account information, the identification information of the OTP generation module, and/or the service identification code that are correlated with each other are received, the authentication server 300 may request the user terminal 200 to verify the biometric information associated with the account information, the identification information of the OTP generation module, and/or the service identification code.

In operation 625, the user terminal 200 may obtain the biometric information from the user. For example, the user terminal 200 may scan a fingerprint pattern or an iris pattern of the user by using a biometric sensor and may obtain fingerprint information or iris information that includes at least a portion of the scanned image.

In operation 630, the user terminal 200 may compare the obtained biometric information with the registration-requested biometric information. For example, the user terminal 200 may determine whether the obtained biometric information is the same as the registration-requested biometric information. The registration-requested biometric information may be one of pieces of biometric information stored in the user terminal 200. If information that is the same as the biometric information stored in the user terminal 200 is obtained, the user terminal 200 may generate a public key to be transmitted to the authentication server 300.

In operation 635, the user terminal 200 may transmit the verification result to the authentication server 300. For example, if the information that is the same as the biometric information stored in the user terminal 200 is obtained, the user terminal 200 may transmit the verification result to the authentication server 300. The user terminal 200 may transmit the public key generated together with the verification result to the authentication server 300.

In operation 640, the authentication server 300 may store identification information of the biometric information, the identification information of the OTP generation module, and the service identification code. For example, if the verification result is received, the authentication server 300 may store the pieces of information, which is received in operation 615, to a nonvolatile memory. The authentication server 300 may store the public key received from the user terminal 200.

In operation 645, the authentication server 300 may request the service providing server 100 to register the biometric information. For example, after storing pieces of information received in operation 615, the authentication server 300 may request the service providing server 100 to register the biometric information associated with the stored pieces of information.

In operation 650, the service providing server 100 may transmit the identification information of the OTP generation module and the OTP generation module corresponding to the identification information to the user terminal 200. For example, the service providing server 100 may transmit the module identification information, which is transmitted to the authentication server 300 in response to the request in operation 615, and the OTP generation module corresponding to the module identification information to the user terminal 200. The service providing server 100 may register the biometric information associated with the module identification information and the OTP generation module.

In operation 655, the user terminal 200 may store the identification information of the OTP generation module and the OTP generation module. For example, the user terminal 200 may store the received identification information of the OTP generation module and OTP generation module in a memory.

In operations 605, 610, 615, 620, 625, 630, 635, 640, 645, 650, and 655, the biometric information stored in the user terminal 200 may be registered in the service providing server 100.

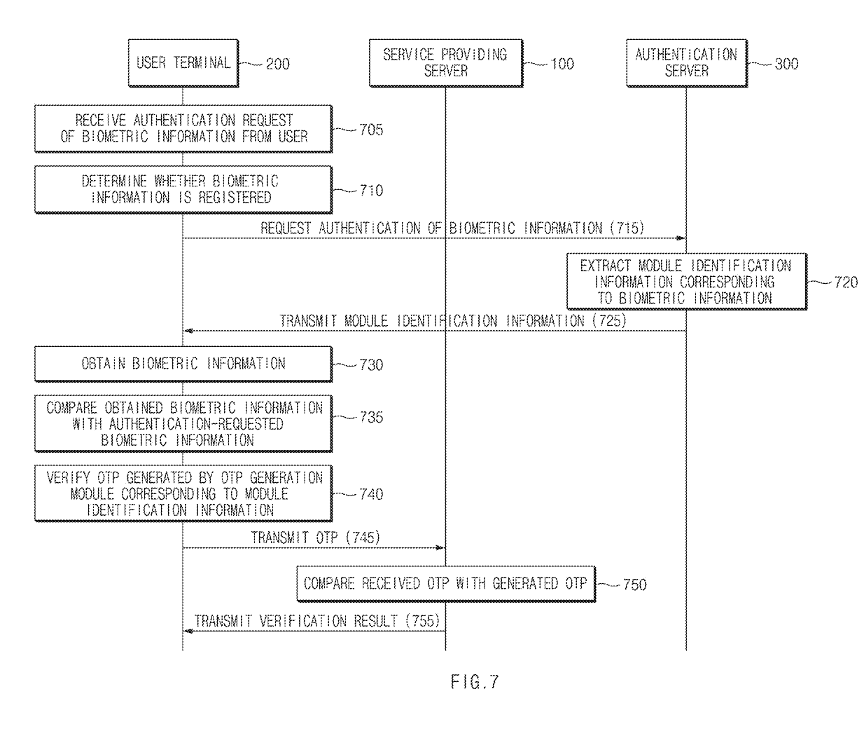

FIG. 7 is a flowchart for describing a biometric information authentication method according to an embodiment of the present disclosure.

The flowchart illustrated in FIG. 7 may include operations that the service providing server 100, the user terminal 200, and the authentication server 300 illustrated in FIGS. 1 to 4 process. Accordingly, although omitted below, details about the service providing server 100, the user terminal 200, and the authentication server 300 described with reference to FIGS. 1 to 4 may be applied to the flowchart illustrated in FIG. 7.

According to various embodiments of the present disclosure, the service providing server 100 may authenticate biometric information in response to a request of the user terminal 200. An operation of authenticating the biometric information will be described below.

Referring to FIG. 7, in operation 705, the user terminal 200 may receive an authentication request of the biometric information from a user. For example, after a service application is executed, the user terminal 200 may receive the authentication request using the registered biometric information.

In operation 710, the user terminal 200 may determine whether the biometric information is registered. For example, the user terminal 200 may determine whether the biometric information stored in the user terminal 200 is registered in the service providing server 100. The user terminal 200 may determine whether the biometric information is registered, based on pieces of information associated with the biometric information.

In operation 715, the user terminal 200 may request the authentication server 300 to authenticate the biometric information. For example, if the registration of the biometric information is verified, the user terminal 200 may request the authentication server 300 to authenticate the biometric information of which the registration is verified. The user terminal 200 may request the authentication through the service providing server 100. The user terminal 200 may request the authentication from the service providing server 100. In this case, the service providing server 100 may request the authentication from the authentication server 300.

In operation 720, the authentication server 300 may extract the identification information of an OTP generation module corresponding to the biometric information. For example, the authentication server 300 may extract the identification information of the OTP generation module corresponding to the biometric information that the user terminal 200 requests the authentication server 300 to authenticate. The authentication server 300 may extract module identification information associated with the identification information based on identification information of the authentication-requested biometric information (e.g., identification information of biometric information or identification information of biometric information for each service). Herein, the module identification information may be the module identification information stored in operation 640 illustrated in FIG. 6.

In operation 725, the authentication server 300 may transmit the identification information of the OTP generation module to the user terminal 200. For example, if the module identification information associated with the biometric information is extracted, the authentication server 300 may transmit the extracted module identification information to the user terminal 200. The authentication server 300 may transmit a verification request of the biometric information to the user terminal 200 together with the module identification information.

In operation 730, the user terminal 200 may obtain the biometric information from the user. For example, the user terminal 200 may scan a fingerprint pattern or an iris pattern of the user by using a biometric sensor and may obtain fingerprint information or iris information that includes at least a portion of the scanned image.

In operation 735, the user terminal 200 may compare the obtained biometric information with the authentication-requested biometric information. For example, the user terminal 200 may determine whether the obtained biometric information is the same as the authentication-requested biometric information. The authentication-requested biometric information may be one of pieces of biometric information stored in the user terminal 200. If information that is the same as the biometric information stored in the user terminal 200 is obtained, the user terminal 200 may generate a signature value by using a public key corresponding to the biometric information.

According to an embodiment of the present disclosure, the user terminal 200 may transmit the verification result, in which the signature value is included, to the authentication server 300. The authentication server 300 may verify the signature value by using the public key stored in the authentication server 300. If the signature value is verified, the authentication server 300 may transmit the authentication result of the biometric information to the user terminal 200.

In operation 740, the user terminal 200 may verify an OTP generated by the OTP generation module corresponding to the identification information of the OTP generation module. For example, if the biometric information is completely authenticated by the authentication server 300, the user terminal 200 may generate an OTP by using the OTP generation module corresponding to the module identification information received in operation 725.

In operation 745, the user terminal 200 may transmit the generated OTP to the service providing server 100. The user terminal 200 may transmit the module identification information associated with the OTP or the identification information of the biometric information for each service to the service providing server 100 together with the OTP

In operation 750, the service providing server 100 may compare the received OTP with an OTP generated by the service providing server 100. For example, the service providing server 100 may generate the OTP by using the OTP generation module corresponding to the module identification information of operation 725. The service providing server 100 may compare the OTP of the user terminal 200 with an OTP of the service providing server 100. If the OTP generation module generating the OTP of the user terminal 200 is the same as an OTP generation module generating the OTP of the service providing server 100 and a time period in which the OTP of the user terminal 200 is generated is the same as a time period in which the OTP of the service providing server 100 is generated, the OTP of the user terminal 200 may be the same as the OTP of the service providing server 100. As described above, since the OTP is automatically transmitted and compared if the biometric information is authenticated by the authentication server 300, an additional input may not be requested from a user for OTP authentication, thereby improving the convenience of the authentication.

In operation 755, the service providing server 100 may transmit the verification result to the user terminal 200. For example, if the OTP of the user terminal 200 is the same as the OTP of the service providing server 100, the service providing server 100 may complete the authentication and may transmit the authentication result to the user terminal 200. If the authentication is completed, the user terminal 200 may use a service provided by the service providing server 100.

In operations 705, 710, 715, 720, 725, 730, 735, 740, 745, 750, and 755, authentication of the service providing server 100 and the authentication server 300 may be performed by using the biometric information stored in the user terminal 200.

As described above, additional authentication may be performed between the service providing server 100 and the user terminal 200 by using an OTP generation module, which is stored in only the service providing server 100 and the user terminal 200, corresponding to module identification information stored in the service providing server 100, the user terminal 200, and the authentication server 300. Even through a security issue of the authentication server 300 occurs, the damage of the service provider and the user due to a security incident may be prevented.

According to an embodiment of the present disclosure, a biometric information authenticating method of a server that provides a service may include transmitting module identification information, which is associated with account information of a user terminal, from among pieces of module identification information to an authentication server in response to a registration request of biometric information received from the user terminal and transmitting the module identification information and an OTP generation module corresponding to the module identification information to the user terminal, if the authentication server verifies the biometric information by using the user terminal.

According to another embodiment, the method may further include correlating the account information, the module identification information, and a service identification code associated with the service with each other and storing the account information, the module identification information, and the service identification code that are correlated with each other.

According to another embodiment, the method may further include generating identification information of biometric information for each service that corresponds to the account information, the module identification information, and the service identification code. The transmitting of the module identification information to the authentication server may include transmitting the account information, the module identification information, the service identification code, and the identification information of the biometric information for each service to the authentication server.

According to another embodiment, the method may further include receiving, from the authentication server, identification information of the biometric information associated with the module identification information and an authentication issuer identification code associated with the authentication server, if the authentication server verifies the biometric information by using the user terminal and storing the identification information of the biometric information and the authentication issuer identification code.

According to another embodiment, the method may further include generating an OTP based on a current time by using the OTP generation module.

According to another embodiment, the method may further include receiving an OTP of the user terminal, which is generated by the OTP generation module stored in the user terminal, from the user terminal if the user terminal authenticates the biometric information by using the authentication server and transmitting the authentication result to the user terminal if the OTP of the user terminal is the same as an OTP of the server generated by the OTP generation module stored in the server.

According to another embodiment, the method may further include receiving the module identification information stored in the user terminal from the user terminal together with the OTP of the user terminal and comparing the OTP of the user terminal with the OTP of the server generated by the OTP generation module corresponding to the module identification information.

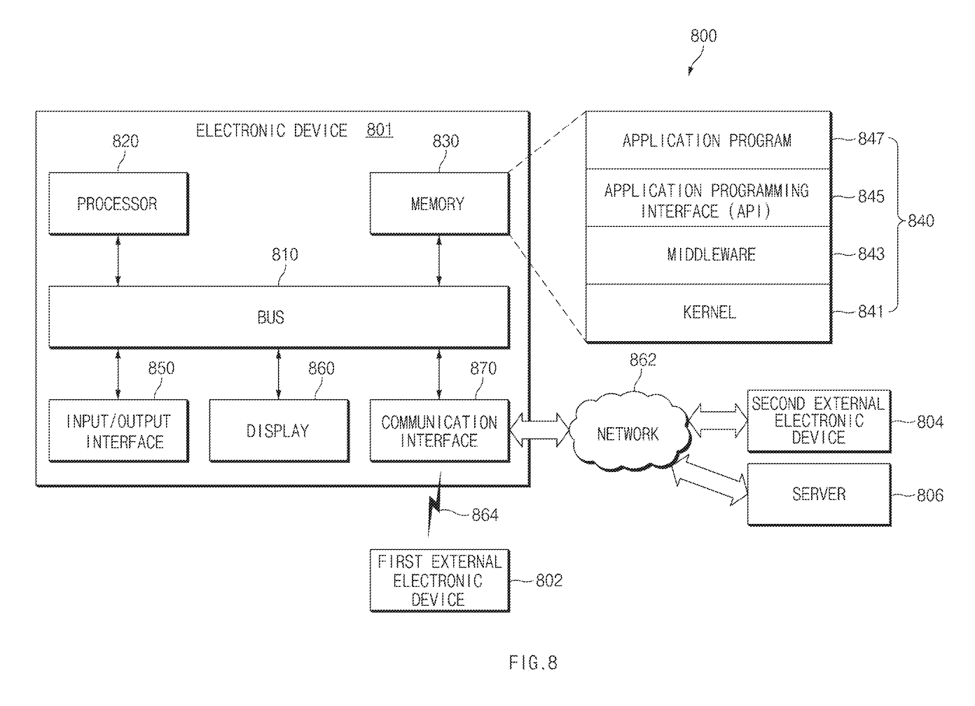

FIG. 8 illustrates an electronic device in a network environment 800 according to various embodiments of the present disclosure.

Referring to FIG. 8, according to various embodiments of the present disclosure, an electronic device 801, a first external electronic device 802, or a second external electronic device 804 or a server 806 may be connected with each other through a network 862 or short range communication 864. The electronic device 801 may include a bus 810, a processor 820, a memory 830, an input/output (I/O) interface 850, a display 860, and a communication interface 870. According to an embodiment of the present disclosure, the electronic device 801 may not include at least one of the above-described elements or may further include other element(s).

The bus 810 may interconnect the above-described elements 820, 830, 850, 860 and 870 and may be a circuit for conveying communications (e.g., a control message and/or data) among the above-described elements.

The processor 820 may include one or more of a CPU, an AP, or a communication processor (CP). The processor 820 may perform, for example, data processing or an operation associated with control or communication of at least one other element(s) of the electronic device 801.

The memory 830 may include a volatile and/or nonvolatile memory. For example, the memory 830 may store instructions or data associated with at least one other element(s) of the electronic device 801. According to an embodiment of the present disclosure, the memory 830 may store software and/or a program 840. The program 840 may include, for example, a kernel 841, a middleware 843, an application programming interface (API) 845, and/or an application program (or “application”) 847. At least a part of the kernel 841, the middleware 843, or the API 845 may be called an “operating system (OS)”.

The kernel 841 may control or manage system resources (e.g., the bus 810, the processor 820, the memory 830, and the like) that are used to execute operations or functions of other programs (e.g., the middleware 843, the API 845, and the application program 847). Furthermore, the kernel 841 may provide an interface that allows the middleware 843, the API 845, or the application program 847 to access discrete elements of the electronic device 801 so as to control or manage system resources.

The middleware 843 may perform, for example, a mediation role such that the API 845 or the application program 847 communicates with the kernel 841 to exchange data.

Furthermore, the middleware 843 may process one or more task requests received from the application program 847 according to a priority. For example, the middleware 843 may assign the priority, which makes it possible to use a system resource (e.g., the bus 810, the processor 820, the memory 830, or the like) of the electronic device 801, to at least one of the application program 847. For example, the middleware 843 may process the one or more task requests according to the priority assigned to the at least one, which makes it possible to perform scheduling or load balancing on the one or more task requests.

For example, the API 845 may be an interface through which the application program 847 controls a function provided by the kernel 841 or the middleware 843, and may include, for example, at least one interface or function (e.g., an instruction) for a file control, a window control, image processing, a character control, or the like.

The I/O interface 850 may transmit an instruction or data, input from a user or another external device, to another element(s) of the electronic device 801. Furthermore, the I/O interface 850 may output an instruction or data, received from another element(s) of the electronic device 801, to a user or another external device.

The display 860 may include, for example, a liquid crystal display (LCD), a light-emitting diode (LED) display, an organic LED (OLED) display, a microelectromechanical systems (MEMS) display, or an electronic paper display. The display 860 may display, for example, various kinds of contents (e.g., a text, an image, a video, an icon, a symbol, or the like) to a user. The display 860 may include a touch screen and may receive, for example, a touch, gesture, proximity, or hovering input using an electronic pen or a portion of a user's body.

The communication interface 870 may establish communication between the electronic device 801 and an external device (e.g., the first external electronic device 802, the second external electronic device 804, or the server 806). For example, the communication interface 870 may be connected to the network 862 through wireless communication or wired communication to communicate with the external device (e.g., the second external electronic device 804 or the server 806).

The wireless communication may include at least one of, for example, a long-term evolution (LTE), an LTE advance (LTE-A), a code division multiple access (CDMA), a wideband CDMA (WCDMA), a universal mobile telecommunications system (UMTS), a wireless broadband (WiBro), a global system for mobile communications (GSM), or the like, as a cellular communication protocol. Furthermore, the wireless communication may include, for example, the short-range communication 864. The short-range communication 864 may include at least one of a wireless fidelity (Wi-Fi), a Bluetooth (BT), a near field communication (NFC), a magnetic stripe transmission (MST), a GNSS, or the like.

The MST may generate a pulse in response to transmission data by using an electromagnetic signal, and the pulse may generate a magnetic field signal. The electronic device 801 may send the magnetic field signal to POS. The POS may detect the magnetic field signal using a MST reader and may recover the data by converting the detected magnetic field signal to an electrical signal.

The GNSS may include at least one of a global positioning system (GPS), a global navigation satellite system (Glonass), a Beidou Navigation Satellite System (hereinafter referred to as “Beidou”), or a European global satellite-based navigation system (Galileo). Hereinafter, “GPS” and “GNSS” may be used interchangeably in the present disclosure. The wired communication may include at least one of, for example, a universal serial bus (USB), a high definition multimedia interface (HDMI), a recommended standard-232 (RS-232), a plain old telephone service (POTS), or the like. The network 862 may include at least one of telecommunications networks, for example, a computer network (e.g., local area network (LAN) or wide area network (WAN)), an Internet, or a telephone network.

Each of the first and second external electronic devices 802 and 804 may be a device of which the type is different from or the same as that of the electronic device 801. According to an embodiment of the present disclosure, the server 806 may include a server or a group of two or more servers. According to various embodiments of the present disclosure, all or a part of operations that the electronic device 801 will perform may be executed by another or plural electronic devices (e.g., the first external electronic device 802 or the second external electronic device 804 or the server 806). According to an embodiment of the present disclosure, in the case where the electronic device 801 executes any function or service automatically or in response to a request, the electronic device 801 may not perform the function or the service internally, but, alternatively additionally, it may request at least a portion of a function associated with the electronic device 801 from other devices (e.g., the first external electronic device 802 or the second external electronic device 804 or the server 806). The other electronic device (e.g., the first external electronic device 802 or the second external electronic device 804 or the server 806) may execute the requested function or additional function and may transmit the execution result to the electronic device 801. The electronic device 801 may provide the requested function or service by processing the received result as it is, or additionally. To this end, for example, cloud computing, distributed computing, or client-server computing may be used.

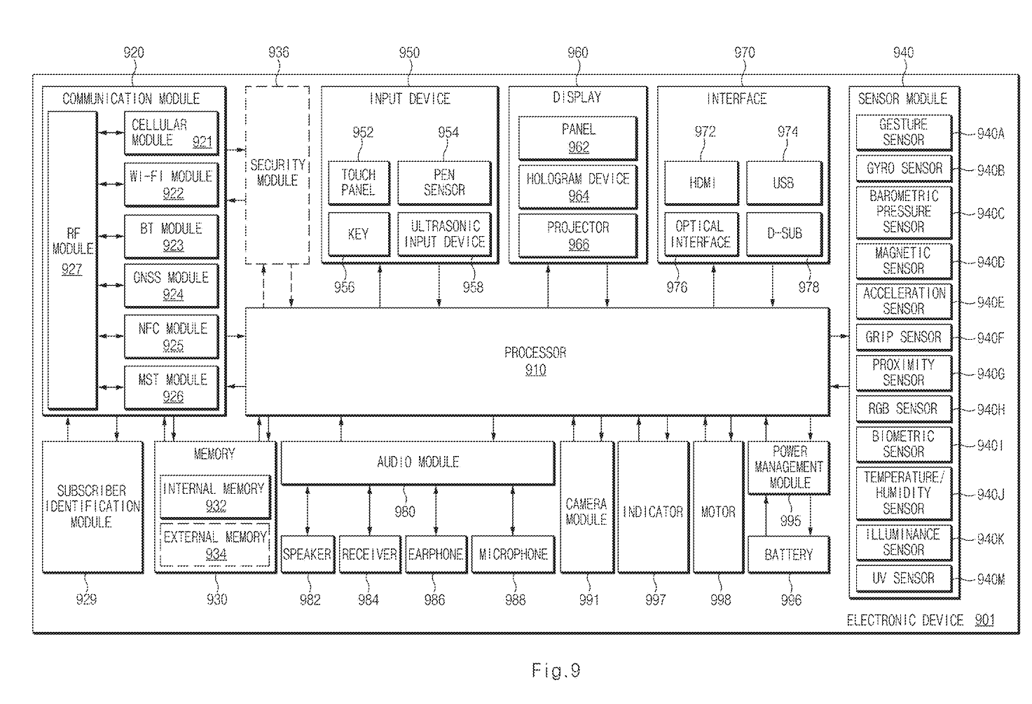

FIG. 9 illustrates a block diagram of an electronic device according to various embodiments of the present disclosure.

Referring to FIG. 9, an electronic device 901 may include, for example, all or a part of the electronic device 801 illustrated in FIG. 8. The electronic device 901 may include one or more processors (e.g., an AP) 910, a communication module 920, a subscriber identification module (SIM) 929, a memory 930, a sensor module 940, an input device 950, a display 960, an interface 970, an audio module 980, a camera module 991, a power management module 995, a battery 996, an indicator 997, and a motor 998.

The processor 910 may drive an OS or an application program to control a plurality of hardware or software elements connected to the processor 910 and may process and compute a variety of data. The processor 910 may be implemented with a system on chip (SoC), for example. According to an embodiment of the present disclosure, the processor 910 may further include a graphic processing unit (GPU) and/or an image signal processor (ISP). The processor 910 may include at least a part (e.g., a cellular module 921) of elements illustrated in FIG. 9. The processor 910 may load and process an instruction or data, which is received from at least one of other elements (e.g., a nonvolatile memory), and may store a variety of data in a nonvolatile memory.

The communication module 920 may be configured the same as or similar to the communication interface 870 of FIG. 8. The communication module 920 may include the cellular module 921, a Wi-Fi module 922, a BT module 923, a GNSS module 924 (e.g., a GPS module, a Glonass module, a Beidou module, or a Galileo module), a NFC module 925, an MST module 926, and a radio frequency (RF) module 927.

The cellular module 921 may provide voice communication, video communication, a character service, an Internet service, or the like through a communication network. According to an embodiment of the present disclosure, the cellular module 921 may perform discrimination and authentication of the electronic device 901 within a communication network using the SIM 929 (e.g., a SIM card). According to an embodiment of the present disclosure, the cellular module 921 may perform at least a portion of functions that the processor 910 provides. According to an embodiment of the present disclosure, the cellular module 921 may include a CP.

Each of the Wi-Fi module 922, the BT module 923, the GNSS module 924, the NFC module 925, or the MST module 926 may include a processor for processing data exchanged through a corresponding module, for example. According to an embodiment of the present disclosure, at least a part (e.g., two or more elements) of the cellular module 921, the Wi-Fi module 922, the BT module 923, the GNSS module 924, the NFC module 925, or the MST module 926 may be included within one integrated circuit (IC) or an IC package.

The RF module 927 may transmit and receive, for example, a communication signal (e.g., an RF signal). For example, the RF module 927 may include a transceiver, a power amplifier module (PAM), a frequency filter, a low noise amplifier (LNA), an antenna, or the like. According to another embodiment, at least one of the cellular module 921, the Wi-Fi module 922, the BT module 923, the GNSS module 924, the NFC module 925, or the MST module 926 may transmit and receive an RF signal through a separate RF module.

The SIM 929 may include, for example, a card and/or embedded SIM which includes a SIM and may include unique identification information (e.g., IC card identifier (ICCID)) or subscriber information (e.g., integrated mobile subscriber identity (IMSI)).

For example, the memory 930 (e.g., the memory 830) may include an internal memory 932 or an external memory 934. For example, the internal memory 932 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, a NOR flash, or the like)), a hard drive, or a solid state drive (SSD).

The external memory 934 may further include a flash drive such as compact flash (CF), secure digital (SD), micro-SD, mini-SD, extreme digital (xD), a multimedia card (MMC), a memory stick, or the like. The external memory 934 may be functionally and/or physically connected with the electronic device 901 through various interfaces.

A security module 936 may be a module that includes a storage space of which a security level is higher than that of the memory 930 and may be a circuit that guarantees safe data storage and a protected execution environment. The security module 936 may be implemented with a separate circuit and may include a separate processor. For example, the security module 936 may be in a smart chip or a SD card, which is removable, or may include an embedded secure element (eSE) embedded in a fixed chip of the electronic device 901. Furthermore, the security module 936 may operate based on an OS that is different from the OS of the electronic device 901. For example, the security module 936 may operate based on java card open platform (JCOP) OS.

The sensor module 940 may measure, for example, a physical quantity or may detect an operating state of the electronic device 901. The sensor module 940 may convert the measured or detected information to an electric signal. For example, the sensor module 940 may include at least one of a gesture sensor 940A, a gyro sensor 940B, a barometric pressure sensor 940C, a magnetic sensor 940D, an acceleration sensor 940E, a grip sensor 940F, a proximity sensor 940G, a color sensor 940H (e.g., a red, green, blue (RGB) sensor), a biometric sensor 940I, a temperature/humidity sensor 940J, an illuminance sensor 940K, or an ultraviolet (UV) sensor 940M. Although not illustrated, additionally or generally, the sensor module 940 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 940 may further include a control circuit that controls at least one or more sensors included therein. According to an embodiment of the present disclosure, the electronic device 901 may further include a processor which is a part of the processor 910 or independent of the processor 910 and is configured to control the sensor module 940. The processor may control the sensor module 940 while the processor 910 remains at a sleep state.

The input device 950 may include, for example, a touch panel 952, a (digital) pen sensor 954, a key 956, or an ultrasonic input device 958. The touch panel 952 may use at least one of capacitive, resistive, IR and ultrasonic detecting methods. Also, the touch panel 952 may further include a control circuit. The touch panel 952 may further include a tactile layer to provide a tactile reaction to a user.

The (digital) pen sensor 954 may be, for example, a part of a touch panel or may include an additional sheet for recognition. The key 956 may include, for example, a physical button, an optical key, a keypad, and the like. The ultrasonic input device 958 may detect (or sense) an ultrasonic signal, which is generated from an input device, through a microphone (e.g., a microphone 988) and may verify data corresponding to the detected ultrasonic signal.

The display 960 (e.g., the display 860) may include a panel 962, a hologram device 964, or a projector 966. The panel 962 may be configured the same as or similar to the display 860 of FIG. 8. The panel 962 may be implemented to be flexible, transparent or wearable, for example. The panel 962 and the touch panel 952 may be integrated into a single module. The hologram device 964 may display a stereoscopic image in a space using a light interference phenomenon. The projector 966 may project light onto a screen so as to display an image. The screen may be arranged inside or outside the electronic device 901. According to an embodiment of the present disclosure, the display 960 may further include a control circuit for controlling the panel 962, the hologram device 964, or the projector 966.

The interface 970 may include, for example, an HDMI 972, a USB 974, an optical interface 976, or a D-subminiature (D-sub) 978. The interface 970 may be included, for example, in the communication interface 870 illustrated in FIG. 8. Additionally or generally, the interface 970 may include, for example, a mobile high definition link (MHL) interface, a SD card/MMC interface, or an IR data association (IrDA) standard interface.

The audio module 980 may convert a sound and an electric signal in dual directions. At least a part of the audio module 980 may be included, for example, in the I/O interface 850 illustrated in FIG. 8. The audio module 980 may process, for example, sound information that is input or output through a speaker 982, a receiver 984, an earphone 986, or the microphone 988.

The camera module 991 for shooting a still image or a video may include, for example, at least one image sensor (e.g., a front sensor or a rear sensor), a lens, an ISP, or a flash (e.g., an LED or a xenon lamp).

The power management module 995 may manage, for example, power of the electronic device 901. According to an embodiment of the present disclosure, the power management module 995 may include a power management IC (PMIC), a charger IC, or a battery or fuel gauge. The PMIC may have a wired charging method and/or a wireless charging method. The wireless charging method may include, for example, a magnetic resonance method, a magnetic induction method, or an electromagnetic method and may further include an additional circuit, for example, a coil loop, a resonant circuit, a rectifier, or the like. The battery gauge may measure, for example, a remaining capacity of the battery 996 and a voltage, current or temperature thereof while the battery is charged. The battery 996 may include, for example, a rechargeable battery and/or a solar battery.

The indicator 997 may display a specific state of the electronic device 901 or a part thereof (e.g., the processor 910), such as a booting state, a message state, a charging state, or the like. The motor 998 may convert an electrical signal into a mechanical vibration and may generate the following effects: vibration, haptic, and the like. Although not illustrated in FIG. 9, the electronic device 901 may include a processing device (e.g., a GPU) for supporting a mobile TV. The processing device for supporting a mobile TV may process media data according to the standards of digital multimedia broadcasting (DMB), digital video broadcasting (DVB), MediaFLO™, or the like.

Each of the above-mentioned elements of the electronic device according to various embodiments of the present disclosure may be configured with one or more components, and the names of the elements may be changed according to the type of the electronic device. According to various embodiments of the present disclosure, the electronic device may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

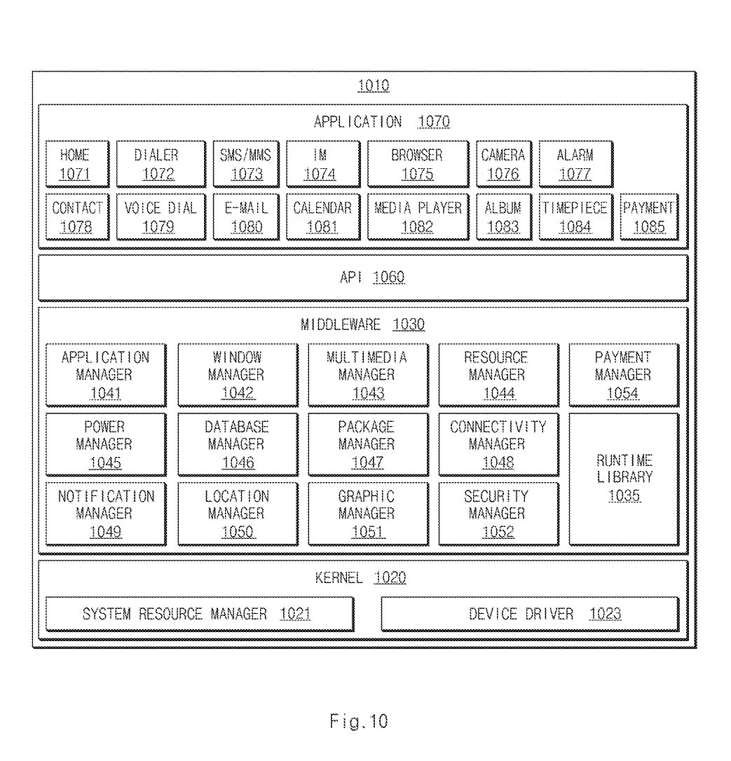

FIG. 10 illustrates a block diagram of a program module according to various embodiments of the present disclosure.

Referring to FIG. 10, according to an embodiment of the present disclosure, a program module 1010 (e.g., the program 840) may include an OS to control resources associated with an electronic device (e.g., the electronic device 801), and/or diverse applications (e.g., the application program 847) driven on the OS. The OS may be, for example, Android™, iOS™, Windows™, Symbian™, Tizen™, Bada™, or the like.

The program module 1010 may include a kernel 1020, a middleware 1030, an API 1060, and/or an application 1070. At least a part of the program module 1010 may be preloaded on an electronic device or may be downloadable from an external electronic device (e.g., the first external electronic device 802 or the second external electronic device 804, the server 806, or the like).

The kernel 1020 (e.g., the kernel 841) may include, for example, a system resource manager 1021, or a device driver 1023. The system resource manager 1021 may perform control, allocation, or retrieval of system resources. According to an embodiment of the present disclosure, the system resource manager 1021 may include a process managing part, a memory managing part, a file system managing part, or the like. The device driver 1023 may include, for example, a display driver, a camera driver, a BT driver, a common memory driver, an USB driver, a keypad driver, a Wi-Fi driver, an audio driver, or an inter-process communication (IPC) driver.

The middleware 1030 may provide, for example, a function which the application 1070 needs in common or may provide diverse functions to the application 1070 through the API 1060 to allow the application 1070 to efficiently use limited system resources of the electronic device. According to an embodiment of the present disclosure, the middleware 1030 (e.g., the middleware 843) may include at least one of a runtime library 1035, an application manager 1041, a window manager 1042, a multimedia manager 1043, a resource manager 1044, a power manager 1045, a database manager 1046, a package manager 1047, a connectivity manager 1048, a notification manager 1049, a location manager 1050, a graphic manager 1051, a security manager 1052, or a payment manager 1054.

The runtime library 1035 may include, for example, a library module, which is used by a compiler, to add a new function through a programming language while the application 1070 is being executed. The runtime library 1035 may perform I/O management, memory management, capacities about arithmetic functions, or the like.

The application manager 1041 may manage, for example, a life cycle of at least one application of the application 1070. The window manager 1042 may manage a GUI resource which is used in a screen. The multimedia manager 1043 may identify a format necessary to play diverse media files, and may perform encoding or decoding of media files by using a codec suitable for the format. The resource manager 1044 may manage resources such as a storage space, memory, or source code of at least one application of the application 1070.

The power manager 1045 may operate, for example, with a basic input/output system (BIOS) to manage a battery or power, and may provide power information for an operation of an electronic device. The database manager 1046 may generate, search for, or modify database to be used in at least one application of the application 1070. The package manager 1047 may install or update an application which is distributed in the form of a package file.

The connectivity manager 1048 may manage, for example, wireless connection such as Wi-Fi or BT. The notification manager 1049 may display or notify an event such as an arrival message, an appointment, or a proximity notification in a mode that does not disturb a user. The location manager 1050 may manage location information of an electronic device. The graphic manager 1051 may manage a graphic effect to be provided to a user or a user interface relevant thereto. The security manager 1052 may provide a general security function necessary for system security, user authentication, or the like. According to an embodiment of the present disclosure, in the case where an electronic device (e.g., the electronic device 801) includes a telephony function, the middleware 1030 may further include a telephony manager for managing a voice or video call function of the electronic device.

The middleware 1030 may include a middleware module that combines diverse functions of the above-described elements. The middleware 1030 may provide a module specialized to each OS kind to provide differentiated functions. In addition, the middleware 1030 may remove a part of the preexisting elements, dynamically, or may add new elements thereto.

The API 1060 (e.g., the API 845) may be, for example, a set of programming functions and may be provided with a configuration which is variable depending on an OS. For example, in the case where an OS is the android or the iOS™, it may be permissible to provide one API set per platform. In the case where an OS is the Tizen™, it may be permissible to provide two or more API sets per platform.

The application 1070 (e.g., the application program 847) may include, for example, one or more applications capable of providing functions for a home 1071, a dialer 1072, an short messaging service/multimedia messaging service (SMS/MMS) 1073, an instant message (IM) 1074, a browser 1075, a camera 1076, an alarm 1077, a contact 1078, a voice dial 1079, an e-mail 1080, a calendar 1081, a media player 1082, an album 1083, and a timepiece 1084, a payment 1085, or for offering health care (e.g., measuring an exercise quantity or blood sugar) or environment information (e.g., information of barometric pressure, humidity, or temperature).

According to an embodiment of the present disclosure, the application 1070 may include an application (hereinafter referred to as “information exchanging application” for descriptive convenience) to support information exchange between the electronic device (e.g., the electronic device 801) and an external electronic device (e.g., the first external electronic device 802 or the second external electronic device 804).

The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., the first external electronic device 802 or the second external electronic device 804). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device (e.g., the first external electronic device 802 or the second external electronic device 804) which communicates with the electronic device, an application running in the external electronic device, or a service (e.g., a call service, a message service, or the like) provided from the external electronic device.

According to an embodiment of the present disclosure, the application 1070 may include an application (e.g., a health care application of a mobile medical device, and the like) which is assigned in accordance with an attribute of the external electronic device (e.g., the first external electronic device 802 or the second external electronic device 804). According to an embodiment of the present disclosure, the application 1070 may include an application which is received from an external electronic device (e.g., the server 806 or the first external electronic device 802 or the second external electronic device 804). According to an embodiment of the present disclosure, the application 1070 may include a preloaded application or a third party application which is downloadable from a server. The element titles of the program module 1010 according to the embodiment may be modifiable depending on kinds of OSs.

According to various embodiments of the present disclosure, at least a part of the program module 1010 may be implemented by software, firmware, hardware, or a combination of two or more thereof. At least a part of the program module 1010 may be implemented (e.g., executed), for example, by a processor (e.g., the processor 910). At least a portion of the program module 1010 may include, for example, a module, a program, a routine, sets of instructions, or a process for performing one or more functions.

The term “module” used in the present disclosure may represent, for example, a unit including one or more combinations of hardware, software, and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

According to various embodiments of the present disclosure, at least a part of an apparatus (e.g., modules or functions thereof) or a method (e.g., operations) may be, for example, implemented by instructions stored in a computer-readable storage media in the form of a program module. The instruction, when executed by a processor (e.g., the processor 820), may cause the one or more processors to perform a function corresponding to the instruction. The computer-readable storage media, for example, may be the memory 830.

A computer-readable recording medium may include a hard disk, a magnetic media, a floppy disk, a magnetic media (e.g., a magnetic tape), an optical media (e.g., a compact disc-ROM (CD-ROM) and a DVD, a magneto-optical media (e.g., a floptical disk), and hardware devices (e.g., a ROM, a RAM, or a flash memory). Also, a program instruction may include not only a mechanical code such as things generated by a compiler but also a high-level language code executable on a computer using an interpreter. The above hardware unit may be configured to operate as one or more software modules to perform an operation according to various embodiments of the present disclosure, and vice versa.

Modules or program modules according to various embodiments may include at least one or more of the above-mentioned elements, some of the above-mentioned elements may be omitted, or other additional elements may be further included therein. Operations executed by modules, program modules, or other elements according to various embodiments may be executed by a successive method, a parallel method, a repeated method, or a heuristic method. In addition, a part of operations may be executed in different sequences or may be omitted. Alternatively, other operations may be added.

According to various embodiments of the present disclosure, biometric authentication of which the security is improved may be provided by performing additional authentication by using an OTP that a user terminal and a service providing server share after biometric authentication is performed.

Besides, a variety of effects directly or indirectly understood through this disclosure may be provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A server comprising:
a communication circuit configured to communicate with a user terminal and an authentication server;
a memory configured to store a plurality of one time password (OTP) generation modules and a plurality of module identification information respectively corresponding to the plurality of OTP generation modules; and
a processor electrically connected with the communication circuit and the memory,
wherein the processor is configured to:
transmit, to the authentication server, module identification information, which is associated with account information of the user terminal, from among the plurality of module identification information, in response to a registration request for biometric information received from the user terminal, and
transmit, to the user terminal, the module identification information and an OTP generation module corresponding to the module identification information, when the authentication server verifies the biometric information using the user terminal.

2. The server of claim 1, wherein the processor is further configured to:
correlate the account information, the module identification information, and a service identification code associated with a service with each other, and
store the account information, the module identification information, and the service identification code, which are correlated with each other, in the memory.

3. The server of claim 2, wherein the processor is further configured to:
generate identification information of biometric information for each service that corresponds to the account information, the module identification information, and the service identification code, and
transmit the account information, the module identification information, the service identification code, and the identification information of the biometric information for each service to the authentication server.

4. The server of claim 1, wherein the processor is further configured to:
receive, from the authentication server, identification information of the biometric information associated with the module identification information and an authentication issuer identification code associated with the authentication server, when the authentication server verifies the biometric information by using the user terminal, and
store the identification information of the biometric information and the authentication issuer identification code in the memory.

5. The server of claim 1, wherein the processor is further configured to:
generate an OTP based on a current time, using the OTP generation module.

6. The server of claim 1, wherein the processor is further configured to:
receive, from the user terminal, an OTP of the user terminal, which is generated by the OTP generation module stored in the user terminal, when the user terminal authenticates the biometric information using the authentication server, and
transmit the authentication result to the user terminal, when the OTP of the user terminal is the same as an OTP of the server generated by the OTP generation module stored in the server.

7. The server of claim 6, wherein the processor is further configured to:
receive the module identification information stored in the user terminal together with the OTP of the user terminal from the user terminal, and
compare the OTP of the user terminal with the OTP of the server generated by the OTP generation module corresponding to the module identification information.

8. A method for authenticating biometric information, the method comprising:
transmitting, to an authentication server, module identification information, which is associated with account information of a user terminal, from among a plurality of module identification information, in response to a registration request of biometric information received from the user terminal; and
transmitting, to the user terminal, the module identification information and a one time password (OTP) generation module corresponding to the module identification information, when the authentication server verifies the biometric information using the user terminal.

9. The method of claim 8, further comprising:
correlating the account information, the module identification information, and a service identification code associated with the service with each other; and
storing the account information, the module identification information, and the service identification code that are correlated with each other.

10. The method of claim 9, further comprising:
generating identification information of biometric information for each service that corresponds to the account information, the module identification information, and the service identification code,
wherein the transmitting of the module identification information to the authentication server includes:
transmitting the account information, the module identification information, the service identification code, and the identification information of the biometric information for each service to the authentication server.

11. The method of claim 8, further comprising:
receiving, from the authentication server, identification information of the biometric information associated with the module identification information and an authentication issuer identification code associated with the authentication server, when the authentication server verifies the biometric information using the user terminal; and
storing the identification information of the biometric information and the authentication issuer identification code.

12. The method of claim 8, further comprising:
generating an OTP based on a current time using the OTP generation module.

13. The method of claim 8, further comprising:
receiving, from the user terminal, an OTP of the user terminal, which is generated by the OTP generation module stored in the user terminal, when the user terminal authenticates the biometric information using the authentication server; and
transmitting the authentication result to the user terminal, when the OTP of the user terminal is the same as an OTP of the server generated by the OTP generation module stored in the server.

14. The method of claim 13, further comprising:
receiving, from the user terminal, the module identification information stored in the user terminal together with the OTP of the user terminal; and
comparing the OTP of the user terminal with the OTP of the server generated by the OTP generation module corresponding to the module identification information.

15. An electronic device comprising:
a communication circuit configured to communicate with a service providing server and an authentication server;
a biometric sensor configured to perform biometric recognition;
a memory configured to store a plurality of biometric information and a plurality of identification information respectively corresponding to the plurality of biometric information; and
a processor electrically connected with the communication circuit, the biometric sensor, and the memory,
wherein the processor is configured to:
transmit a registration request for one biometric information of the plurality of biometric information to the service providing server,
receive a verification request of the one biometric information from the authentication server, when the authentication server receives module identification information corresponding to a one time password (OTP) generation module from the service providing server in response to the registration request, and
receive the module identification information and the OTP generation module from the service providing server, when information that is the same as the one biometric information is obtained through the biometric sensor.

16. The electronic device of claim 15, wherein the processor is further configured to:
store the module identification information and the OTP generation module in the memory.

17. The electronic device of claim 15, wherein the processor is further configured to:
transmit identification information of the one biometric information corresponding to the one biometric information to the service providing server or the authentication server, and
transmit the result of the verification request to the authentication server, when the one biometric information corresponding to the identification information of the one biometric information is obtained through the biometric sensor.

18. The electronic device of claim 17, wherein the processor is further configured to:
receive the identification information of the one biometric information and the module identification information from the authentication server, when an authentication request for the one biometric information is received from a user of the electronic device,
generate an OTP using the OTP generation module corresponding to the module identification information received from the authentication server, when the one biometric information corresponding to the identification information of the one biometric information is detected through the biometric sensor, and
transmit the OTP to the service providing server.

19. The electronic device of claim 18, wherein the processor is further configured to:
determine whether the one biometric information is registered, when the authentication request for the one biometric information is received,
transmit the authentication request for the one biometric information to the authentication server, when the registration of the one biometric information is verified, and
receive the identification information of the one biometric information and the module identification information from the authentication server.

20. The electronic device of claim 18, wherein the processor is further configured to:
receive the result of the authentication request from the service providing server, when the OTP is the same as an OTP generated by the service providing server.
